(19) United States
(12) Patent Application Publication
(10) Pub. No.: US 2015/0054747 A1
(43) Pub. Date: Feb. 26, 2015

(54) Circular Keyboard

(71) Applicant: Google Inc., (US)

(72) Inventors: Thad Eugene Starner, Mountain View, CA (US); Nirmal Patel, Mountain View, CA (US)

(73) Assignee: GOOGLE INC., Mountain View, CA (US)

(21) Appl. No.: 13/622,279

(22) Filed: Sep. 18, 2012

Related U.S. Application Data
(60) Provisional application No. 61/584,104, filed on Jan. 6, 2012.

(51) Int. Cl. G06F 3/02

(52) U.S. Cl. 345/168

(57) ABSTRACT

At least one embodiment takes the form of a computing device comprising a processor and a data storage comprising instructions that, if executed by the processor, cause the computing device to present a transition region and one or more input regions. Each input region comprises a respective symbol. The computing device further detects a movement through the transition region (i) originating from a first input region and (ii) exceeding a threshold movement. The computing device then receives an indication comprising the first-input-region symbol.

### CROSS-REFERENCE TO RELATED APPLICATION

This application claims the benefit of U.S. Provisional Application No. 61/584,104, filed Jan. 6, 2012, the entire contents of which are hereby incorporated by reference.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mounted displays” (HMDs). A head-mounted display places a graphic display or displays close to one or both eyes of a wearer. To generate the images on a display, a computer processing system may be used. Such displays may occupy a wearer's entire field of view, or only occupy part of wearer's field of view. Further, head-mounted displays may be as small as a pair of glasses or as large as a helmet.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming.

User interfaces may be arranged to provide various combinations of keys, buttons, and/or, more generally, input regions. Often, user interfaces will include input regions that are associated with multiple characters and/or computing commands. Typically, users may select various characters and/or various computing commands, by performing various input actions relative to the user interface.

As computing devices continue to become smaller and more portable, however, input systems must likewise become smaller. Such smaller input systems can impair the accuracy of user-input. Further, as input systems become smaller, the speed with which a user may use the system may suffer. An improvement is therefore desired.

### SUMMARY

The disclosure herein may provide for more accurate, efficient, and/or faster use of an input system of a computing device. More particularly, the disclosure herein involves techniques for text entry using a circular keyboard.

At least one embodiment takes the form of a method carried out by a computing device. The device presents a transition region and one or more input regions, and detects a movement through the transition region (i) originating from a first input region and (ii) exceeding a threshold movement. Each input region comprises a respective symbol. The device receives an indication comprising the first-input-region symbol.

Another embodiment takes the form of a computing device comprising a processor and a data storage comprising instructions that, if executed by the processor, cause the computing device to present a transition region and one or more input regions. Each input region comprises a respective symbol. The instructions further cause the computing device to detect a movement through the transition region (i) originating from a first input region and (ii) exceeding a threshold movement. Additionally, the instructions cause the computing device to receive an indication comprising the first-input-region symbol, and present a confirmation associated with the indication.

A further embodiment takes the form of a non-transitory computer-readable medium having instructions stored thereon that, if executed by a computing device, cause the computing device to present a transition region and one or more input regions. Each input region comprises a respective symbol. The instructions further cause the computing device to detect a movement through the transition region (i) originating from a first input region and (ii) exceeding a threshold movement. Additionally, the instructions cause the computing device to receive an indication comprising the first-input-region symbol, and present a confirmation associated with the indication.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIGS. 1-3 and 5 depict a user interface, in accordance with one or more embodiments;

FIG. 4 is a flowchart of a method, in accordance with one or more embodiments;

FIGS. 6A and 6B, and 7A and 7B, respectively, depict views of a wearable computing system, in accordance with one or more embodiments; and

FIG. 8 is a simplified block diagram of a computing device, in accordance with one or more embodiments.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that aspects of the present disclosure, as generally described herein, and illustrated in the figures, can be arranged, substituted, combined, separated, and designed in a wide variety of different configurations, all of which are contemplated herein.

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

### I. OVERVIEW

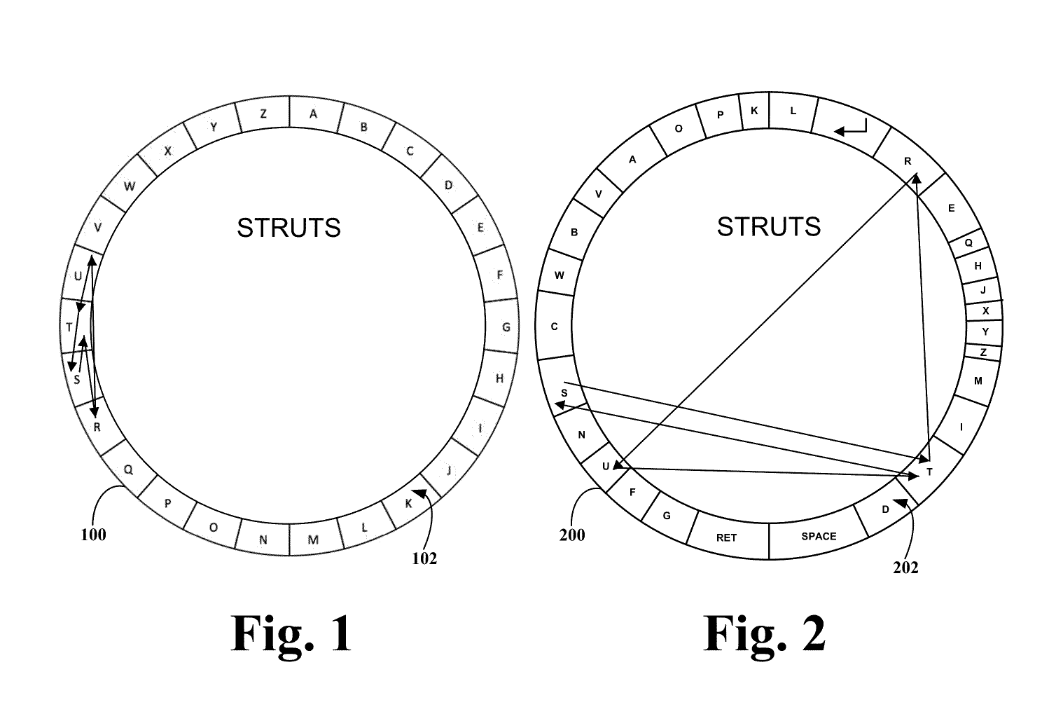

FIGS. 1 and 2 depict user interfaces, in accordance with exemplary embodiments. The user interfaces could be presented by a near-eye display (such as a head-mounted display), among numerous other examples discussed below. As shown in FIG. 1, user interface 100 may include a circular keyboard 102. Similarly, as shown in FIG. 2, user interface 200 may include a circular keyboard 202.

Generally, the user interface may be any user interface that provides a set of input regions, regardless of, for example, shape, size, number, or arrangement of the input regions. The user interface may be communicatively coupled to a graphical display that may provide a visual depiction of the input regions of the user interface along with a visual depiction of the position of a pointer relative to the input regions.

The user interface may take the form of an eye-tracking interface and/or head-tracking interface, among other possibilities. In an embodiment, an eye-tracking interface includes an imaging device that is able to track eye movement and/or eye gaze. In another embodiment, a head tracking interface includes a gyroscope that is able to track head orientation. Those having skill in the art will recognize that other modifications are possible without departing from the scope of the claims. For example, head tracking interface could additionally or alternatively include an accelerometer and/or a magnetometer.

In an embodiment, a user inputs a word via a user interface by looking at the letters of the circular keyboard corresponding to the letters of the word the user wants to input. For example, to enter the word “STRUTS”, the user would look at the letters “S”, “T”, “R”, “U”, “T”, and “S”, in that order. A computing device (such as a head-mounted display) may interact with a sensor (such as a camera) to track the movement of the user's eyes. Other techniques for tracking the movement of the user's eyes may be used as well.

Like many users of traditional computer keyboards who don't remember the exact location of all the keys, a user of interfaces 100 or 200 may have to search for one or more letters on the circular keyboard before selecting that letter. In an embodiment, the computing device distinguishes between selection/input movements and searching movements by interpreting relatively “long” eye movements to be selection movements, and generally ignoring relatively “short” eye movements, which are may be interpreted to be searching movements. Such an approach is generally effective because, in an embodiment, the circular keyboard is arranged so that letters that commonly follow each other are further away from each other and letters that do not commonly follow each other are closer to each other. In other words, the keyboard is arranged so that, whatever word the user is trying to spell, and whatever letter the user is about to input for that word, that letter may be on the other side of the keyboard with a high degree of likelihood, and thus is likely to require a long eye movement. Accordingly, if the user makes a long eye movement, the letter from which the user made the long eye movement is likely the letter the user intended to select. On the other hand, if the user makes a short eye movement, the letter from which the user made the short eye movement is less likely the letter the user intended to select.

FIGS. 1 and 2 depict the eye movements for spelling the word “STRUTS” using a standard and an optimized keyboard, respectively. The letters of the standard keyboard in FIG. 1 are arranged from A to Z, while the letters of the optimized keyboard in FIG. 2 are arranged so that letters that commonly follow each other are further away from each other.

As shown in FIG. 1, the eye movements for spelling the words “STRUTS” using a standard keyboard involve only relatively short eye movements because the keyboard is not optimized, i.e., letters that commonly follow each other are not further away from each other. Accordingly, the computing device may be relatively less efficient when determining whether the user is selecting a letter or simply searching for a nearby letter, and may be unable to determine that the user is intending to spell the word “STRUTS”.

In contrast, as shown in FIG. 2, the eye movements for spelling the word “STRUTS” using the optimized keyboard involve only relatively long eye movements because the keyboard is optimized so that letters that commonly follow each other are further away from each other. The computing device will likely be able to determine that the user is intending to select the corresponding letter with these long eye movements.

It should be understood that the optimization will likely depend on the underlying language that is intended to be optimized. It should further be understood, as briefly noted above, that other input movements besides eye movements may be used as well. For example, the user interface could be implemented using a joystick, and the sensors could track the movement of the joystick. Numerous other modifications are possible as well without departing from the scope of the claims, many of which will be described below.

### II. EXAMPLE USER INTERFACE

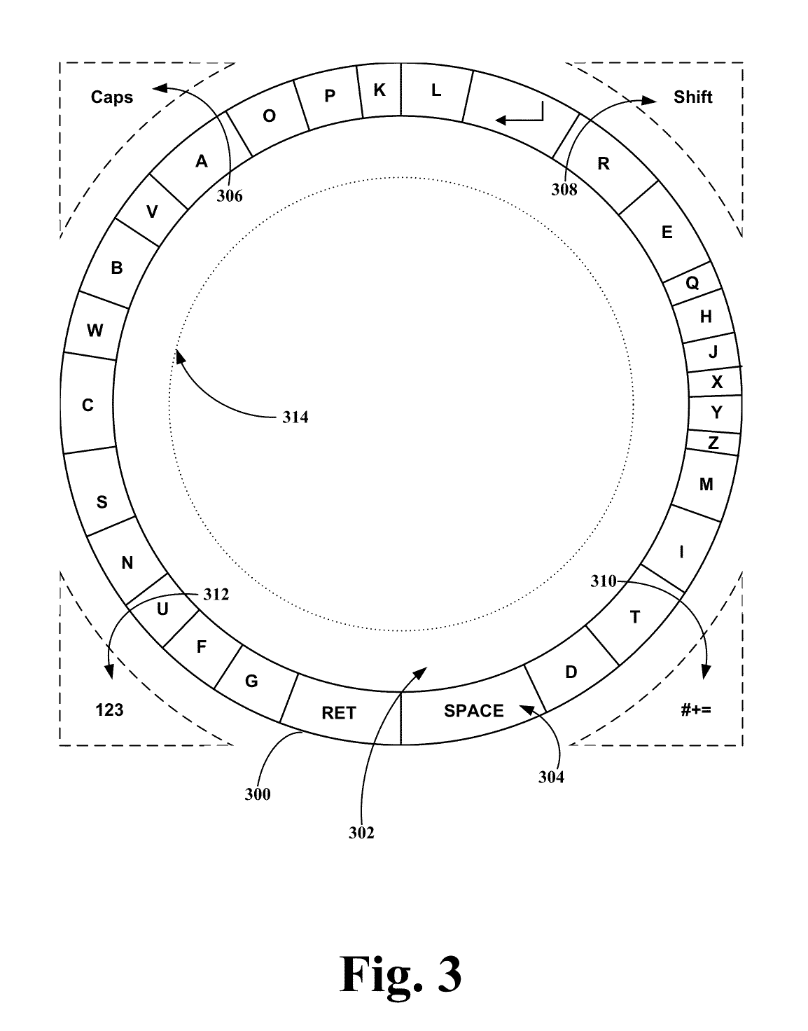

FIG. 3 is a diagram of a user interface, in accordance with one or more embodiments. As shown in FIG. 3, user interface 300 includes transition region 302, one or more input regions 304 and 306-312, and a selection region 314. It should be understood that the arrangements of the input regions, etc. could be determined dynamically by the computing device (and/or another device) and/or could be determined in advanced based on known letter-frequency (or other) information, among other possibilities, without departing from the scope of the claims.

In an embodiment, transition region 302 is generally circular. However, transition region 302 may take the form of other shapes as well, such as a square, a hexagon, and/or an annulus, among other possibilities.

In an embodiment, transition region 302 is larger than one or more of input regions 304. In another embodiment, transition region 302 is larger than every one of input regions 304. As still another possibility, transition region 302 could be larger than the combined area of all of the input regions 304. Alternatively, transition region 302 could be the same size as an input region, or could be smaller than an input region. Other possibilities may exist as well without departing from the scope of the claims.

In an embodiment, at least one of the input regions adjoins the transition region, while other input regions do not adjoin the transition region. To illustrate, as shown in FIG. 3, input regions 306-312 do not adjoin the transition region. In another embodiment, every input region adjoins the transition region. As another possibility, none of the input regions adjoin the transition region. Other arrangements are possible as well.

In an embodiment, each input region is associated with a respective symbol. The symbol may be a letter, a number, and/or any other character, as examples. The character could be associated with the ASCII, Unicode, and/or other character encodings. Further, the symbol could be a combination of symbols—for example, a word or a phrase such a “Shift” or “Space”. It should also be understood that more than one input region may share the same respective symbol.

As noted above, in an embodiment, the letter regions may be arranged so that letter regions with letters that commonly follow each other are generally further away from each other and input regions with letters that do not commonly follow each other are generally closer to each other. A digram is a group of two successive letters or other symbols.

Table 1 shows the thirty-nine most frequent digrams based on a sample of 40,000 words.

TABLE 1

| Rank | Digram | Frequency |
|---|---|---|
| 1 | th | 1.52 |
| 2 | he | 1.28 |
| 3 | in | 0.94 |
| 4 | er | 0.94 |
| 5 | an | 0.82 |
| 6 | re | 0.68 |
| 7 | nd | 0.63 |
| 8 | at | 0.59 |
| 9 | on | 0.57 |
| 10 | nt | 0.56 |
| 11 | ha | 0.56 |
| 12 | es | 0.56 |
| 13 | st | 0.55 |
| 14 | en | 0.55 |
| 15 | ed | 0.53 |
| 16 | to | 0.52 |
| 17 | it | 0.5 |
| 18 | ou | 0.5 |
| 19 | ea | 0.47 |
| 20 | hi | 0.46 |
| 21 | is | 0.46 |
| 22 | or | 0.43 |
| 23 | ti | 0.34 |
| 24 | as | 0.33 |
| 25 | to | 0.27 |
| 26 | et | 0.19 |
| 27 | ng | 0.18 |
| 28 | of | 0.16 |
| 29 | al | 0.09 |
| 30 | de | 0.09 |
| 31 | se | 0.08 |
| 32 | le | 0.08 |
| 33 | sa | 0.06 |
| 34 | si | 0.05 |
| 35 | ar | 0.04 |
| 36 | ye | 0.04 |
| 37 | ra | 0.04 |
| 38 | ld | 0.02 |
| 39 | ur | 0.02 |

In an embodiment, a plurality of input regions includes a letter region, and the respective symbol of each the letter regions includes a letter. Each letter region is arranged so that, for any given digram, the distance between two letter regions comprising a consecutive letter of the digram positively correlates with a frequency of the digram.

For example, with reference to Table 1, the digram “th” occurs with a frequency of 1.52, while the digram “st” occurs with a frequency of 0.55. Given the positive correlation between the frequency of any given digram and the distance between two letter regions comprising a consecutive letter of the digram, the distance between letter region “t” and letter region “h” must be greater than the distance between letter region “s” and letter region “t”.

However, those having skill in the art will recognize that there are other means of maximizing the possibility that a selection of a second symbol in a digram (after having selected the first symbol) will generally require a long eye movement.

For example, when determining an arrangement of letter regions in user interface 300, the computing device may consider (i) the space of all possible arrangement, (ii) a way of “scoring” the optimization of a particular arrangement against any other arrangement, and/or (iii) a way of choosing the next arrangement to explore/optimize/score/etc., among other factors. In an embodiment, the “score” of the input-region or letter-region arrangement is the “digram probability” x “the distance between the letters in order” for all digrams. As one possibility, a higher score indicates that high-frequency digrams are further apart in an arrangement.

In an embodiment, the computing device (or other device) optimizes the letter regions using a “brute force” arrangement. That is, the computing device enumerates all possible arrangements and their scores, and presents or stores the arrangement or arrangements with the highest score(s).

In another embodiment, the computing device chooses a random arrangement. The computing device then uses a stepping function to generate an alternate arrangement by, for example, swapping two letters. If the new arrangement has a higher optimization score, then the computing device will keep the keep the higher-scoring arrangement and discard the lower-scoring arrangement (or store the lower-scoring arrangement to ensure to ensure that it is not re-scored). The computing device may continue the stepping function until it has scored a sufficient number of arrangements to ensure an objectively high-scoring arrangement.

In an embodiment, the size of an input region is dynamically changed based on the likelihood that it will be selected. For example, assume that the letter “h” was just selected. Referring to the two highest-ranked digrams in Table 1, there is a high probably that the letter “t” (1.52) or the letter “e” (1.28) will be selected next. In an embodiment, the size of an input- or letter-region associated with the letters “t” or “e” could be increased based on the increased possibility that these letter regions will be selected next. Similarly, the size of other input regions may be decreased based on the decreased possibility that these letter regions will be selected next.

In an embodiment, input regions 304-312 are sized according to how frequently they are used. For example, as shown in FIG. 3, commonly used functions such as SPACE, BACKSPACE, and RETURN may occupy larger input regions. Similarly, input regions for commonly-used letters such as R, S, and T may be larger than input regions for less-frequently used letters such as Q, X, and Z. Also note that other frequently used functions may be present as well.

Selection region 314 may be any type of region configured to carry out the selection-function regions described below. The region could take the same shape, form, etc. of transition region 302, input regions 304-312, etc. In an embodiment, selection region 314 is a circular region within circular transition region 302. Those having skill in the art will recognize that selection region 314 may take other forms as well.

### III. EXAMPLE OPERATION

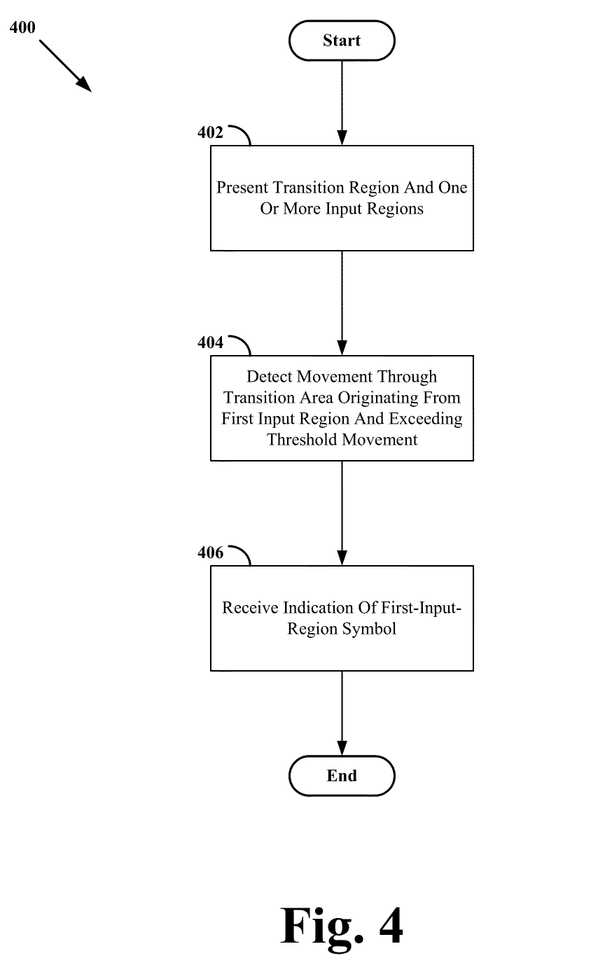

FIG. 4 is a flowchart of a method, in accordance with one or more embodiments. As shown in FIG. 4, method 400 begins at step 402 with a computing device presenting transition region 302 and one or more input regions 304. It should be understood that additional and/or different entities discussed with reference to user interface 300 (such as selection region 314) could be presented as well, and that transition region 302 and/or input regions 304 need not necessarily be presented.

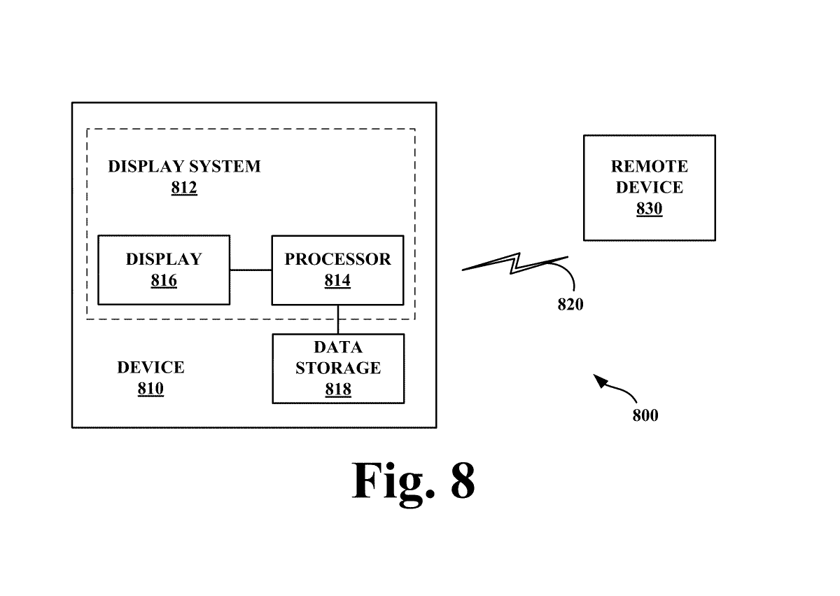

A computing device in accordance with various embodiments is discussed below with reference to FIG. 8. In an embodiment, the computing device is connected to a display, and the computing device presenting transition region 302 and input regions 304 takes the form of the display presenting these regions. The connection between the computing device and the display could be wired and/or wireless.

Method 400 continues at step 404 with the computing device detecting a movement through transition region 302 (i) originating from a first input region and (ii) exceeding a threshold movement.

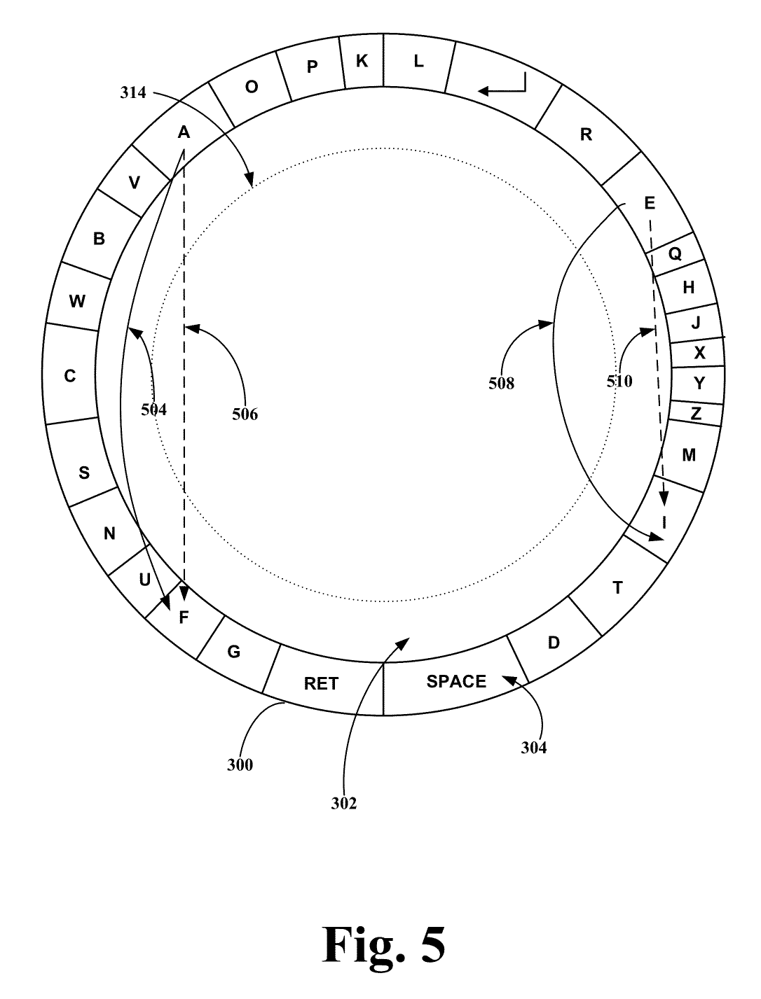

In an embodiment, the threshold movement is a distance, while in another embodiment, the threshold movement is a displacement. FIG. 5 illustrates the difference between a distance and a displacement. Solid-line arrows 504 and 508 represent actual movements, while dashed-line arrows 506 and 510 represent shortest-possible distances of actual movements 504 and 508, respectively. Solid-line arrows 504 and 508 (the actual movements) represent distances, while dashed-line arrows 506 and 510 (the shortest-possible distances) represent displacements.

The threshold movement could be, for example, a movement within selection region 314. In an embodiment, movement within the selection region is an actual movement within the selection region, while in another embodiment, the movement is a displacement through the selection region. Again, FIG. 5 illustrates the difference. As shown, actual movement 504 is not through the selection region, but the associated displacement 506 is through the selection region. In contrast, actual movement 508 is through the selection region, while associated displacement is not through the selection region.

In another embodiment, the threshold movement is a velocity. For example, even though a movement is through the transition region, that movement may be slow enough to suggest that the user is nonetheless searching for (rather than selecting) a letter. In another embodiment, the threshold movement is an acceleration. For example, even though a movement through the transition region may be slow, if that movement is faster than a previous movement (such as a searching movement in one or more input regions), then the computing device may interpret this movement as a threshold movement.

It should be understood that the threshold movement could be a minimum, a maximum, etc., such as a minimum distance, an average acceleration, among other examples. It should also be understood that the threshold movement could include a combination of threshold movements. In an embodiment, the threshold movement includes an actual movement through the selection region, and a minimum velocity before the movement stops. In another embodiment, the threshold movement includes a minimum displacement and a minimum velocity before the movement stops. Those having skill in the art will understand that other thresholds, movements, and combinations are possible as well.

The movement could be a gaze-target movement, e.g., of a user's eye. In an embodiment, detecting a gaze-target movement includes presenting a gaze-target icon at the gaze-target location. The icon could take the form of a dot, a circle, a square, a representation of an eye, etc. In another embodiment, detecting a gaze-target movement includes presenting a gaze-target path, perhaps of the previous eye movement. The path and/or icon could assist the computing-device user in determining whether the gaze-target movement exceeded a threshold movement.

Method 300 continues at step 306 with the computing device receiving an indication comprising the first-input-region symbol.

In an embodiment, the computing device may present a confirmation associated with the indication. For example, the computing device may present the symbol, perhaps in the transition region (as shown in FIGS. 1 and 2). The computing device may present each individual symbol as the indication is received, and/or it could wait until more than one indication is received.

In an embodiment, the computing device may execute a command associated with the indication. For example, the input-region symbol may be “RET”, which may be associated with a typical keyboard “Return” or “Enter” key. In this example, the computing device may not present any symbol at all associated with that input region, but may instead execute a command, perhaps associated with previously-entered text or other symbols.

In an embodiment, the computing device presents a second transition region and/or a second set of input regions. For example, the first input region may be input region 310 (associated with symbols “#+=”) and/or input region 312 (associated with symbols “123”), and may be associated with a second transition region and a set second of input regions. The received indication of the first-input-region symbol may include an indication to present the second transition region and the second set of input regions, and the computing device may responsively present that second transition region and second set of input regions. The second set of input regions could include uppercase letters, lowercase letters, numbers, emoticons, etc.

In an embodiment, auto-correction functionality may be implemented for user interface 300. For example, an auto-correct feature may determine a number of possible intended inputs for each letter that is entered in a sequence of letters (e.g., for a word). These possibilities may be compared to a dictionary to determine possible words that may have been entered. Further, when multiple words are possible, a context filter may be used to select an intended word.

### IV. EXAMPLE WEARABLE COMPUTING DEVICE

Systems and devices in which exemplary embodiments may be implemented will now be described in greater detail. In general, an exemplary system may be implemented in or may take the form of a wearable computer. However, an exemplary system may also be implemented in or take the form of other devices, such as a mobile phone, among others. Further, an exemplary system may take the form of non-transitory computer readable medium, which has program instructions stored thereon that are executable by at a processor to provide the functionality described herein. An exemplary, system may also take the form of a device such as a wearable computer or mobile phone, or a subsystem of such a device, which includes such a non-transitory computer readable medium having such program instructions stored thereon.

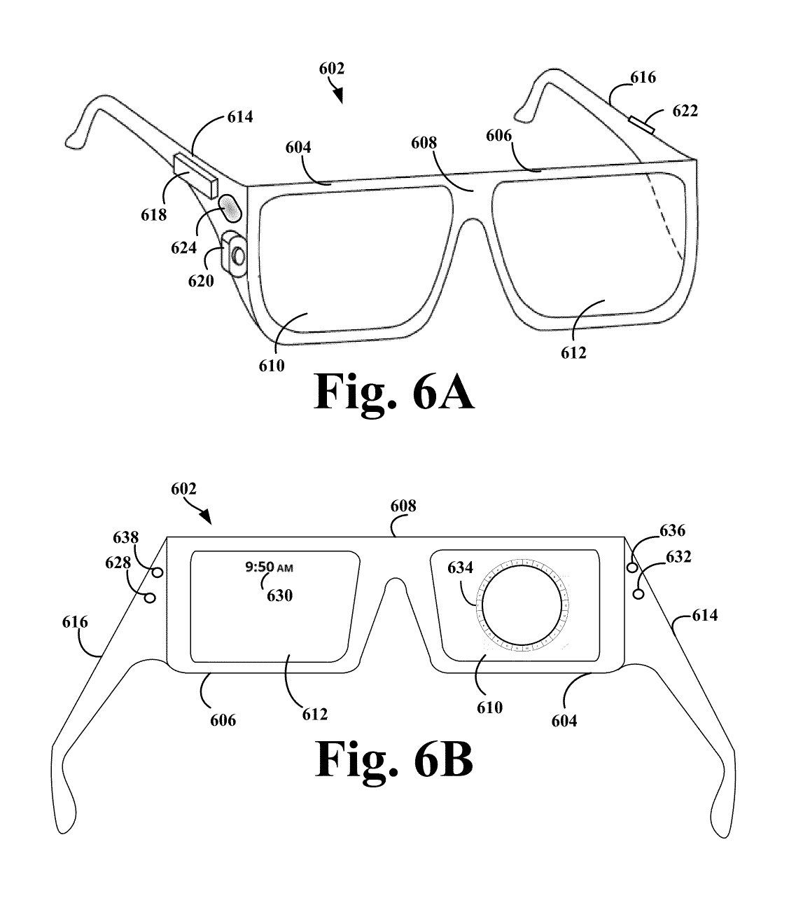

FIG. 6A illustrates a wearable computing system according to an exemplary embodiment. In FIG. 6A, the wearable computing system takes the form of a head-mounted device (HMD) 602 (which may also be referred to as a head-mounted display). It should be understood, however, that exemplary systems and devices may take the form of or be implemented within or in association with other types of devices, without departing from the scope of the invention. As illustrated in FIG. 6A, the head-mounted device 602 includes frame elements including lens-frames 604 and 606 and a center frame support 608, lens elements 610 and 610, and extending side-arms 614 and 616. The center frame support 608 and the extending side-arms 114 and 116 are configured to secure the head-mounted device 602 to a user's face via a user's nose and ears, respectively.

Each of the frame elements 604, 606, and 608 and the extending side-arms 614 and 616 may be formed of a solid structure of plastic and/or metal, or may be formed of a hollow structure of similar material so as to allow wiring and component interconnects to be internally routed through the head-mounted device 602. Other materials may be possible as well.

One or more of each of the lens elements 610 and 612 may be formed of any material that can suitably display a projected image or graphic. Each of the lens elements 610 and 612 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 614 and 616 may each be projections that extend away from the lens-frames 604 and 606, respectively, and may be positioned behind a user's ears to secure the head-mounted device 602 to the user. The extending side-arms 614 and 616 may further secure the head-mounted device 602 to the user by extending around a rear portion of the user's head. Additionally or alternatively, for example, the HMD 602 may connect to or be affixed within a head-mounted helmet structure. Other possibilities exist as well.

The HMD 602 may also include an on-board computing system 618, a video camera 620, a sensor 622, and a finger-operable touch pad 624. The on-board computing system 618 is shown to be positioned on the extending side-arm 614 of the head-mounted device 602; however, the on-board computing system 118 may be provided on other parts of the head-mounted device 602 or may be positioned remote from the head-mounted device 602 (e.g., the on-board computing system 618 could be wire- or wirelessly-connected to the head-mounted device 602). The on-board computing system 618 may include a processor and memory, for example. The on-board computing system 618 may be configured to receive and analyze data from the video camera 620 and the finger-operable touch pad 624 (and possibly from other sensory devices, user interfaces, or both) and generate images for output by the lens elements 610 and 612.

The video camera 620 is shown positioned on the extending side-arm 614 of the head-mounted device 602; however, the video camera 620 may be provided on other parts of the head-mounted device 602. The video camera 620 may be configured to capture images at various resolutions or at different frame rates. Many video cameras with a small form-factor, such as those used in cell phones or webcams, for example, may be incorporated into an example of the HMD 602.

Further, although FIG. 6A illustrates one video camera 620, more video cameras may be used, and each may be configured to capture the same view, or to capture different views. For example, the video camera 620 may be forward facing to capture at least a portion of the real-world view perceived by the user. This forward facing image captured by the video camera 620 may then be used to generate an augmented reality where computer generated images appear to interact with the real-world view perceived by the user.

The sensor 622 is shown on the extending side-arm 616 of the head-mounted device 602; however, the sensor 622 may be positioned on other parts of the head-mounted device 602. The sensor 622 may include one or more of a gyroscope or an accelerometer, for example. Other sensing devices may be included within, or in addition to, the sensor 622 or other sensing functions may be performed by the sensor 622.

The finger-operable touch pad 624 is shown on the extending side-arm 614 of the head-mounted device 602. However, the finger-operable touch pad 624 may be positioned on other parts of the head-mounted device 602. Also, more than one finger-operable touch pad may be present on the head-mounted device 602. The finger-operable touch pad 624 may be used by a user to input commands. The finger-operable touch pad 624 may sense at least one of a position and a movement of a finger via capacitive sensing, resistance sensing, or a surface acoustic wave process, among other possibilities. The finger-operable touch pad 624 may be capable of sensing finger movement in a direction parallel or planar to the pad surface, in a direction normal to the pad surface, or both, and may also be capable of sensing a level of pressure applied to the pad surface. The finger-operable touch pad 624 may be formed of one or more translucent or transparent insulating layers and one or more translucent or transparent conducting layers. Edges of the finger-operable touch pad 624 may be formed to have a raised, indented, or roughened surface, so as to provide tactile feedback to a user when the user's finger reaches the edge, or other area, of the finger-operable touch pad 624. If more than one finger-operable touch pad is present, each finger-operable touch pad may be operated independently, and may provide a different function.

FIG. 6B illustrates an alternate view of the wearable computing device illustrated in FIG. 6A. As shown in FIG. 6B, the lens elements 110 and 112 may act as display elements. The head-mounted device 602 may include a first projector 628 coupled to an inside surface of the extending side-arm 616 and configured to project a display 630 onto an inside surface of the lens element 112. Additionally or alternatively, a second projector 632 may be coupled to an inside surface of the extending side-arm 614 and configured to project a display 634 onto an inside surface of the lens element 610.

The head-mounted device 602 may also include one or more sensors coupled to an inside surface of head-mounted device 602. For example, as shown in FIG. 6B, sensor 636 coupled to an inside surface of the extending side-arm 614, and/or sensor 638 coupled to an inside surface of the extending side-arm 616. The one or more sensors could take the form of a still or video camera (such as a charge-coupled device or CCD), any of the forms discussed with reference to sensor 622, and/or numerous other forms, without departing from the scope of the claims. The one or more sensors (perhaps in coordination with one or more other entities) may be configured to perform eye tracking, such as gaze-target tracking, etc.

The lens elements 610, 612 may act as a combiner in a light projection system and may include a coating that reflects the light projected onto them from the projectors 628 and 632. In some embodiments, a reflective coating may not be used (e.g., when the projectors 628 and 632 are scanning laser devices).

In alternative embodiments, other types of display elements may also be used. For example, the lens elements 110 and 112 themselves may include a transparent or semi-transparent matrix display such as an electroluminescent display or a liquid crystal display, one or more waveguides for delivering an image to the user's eyes, and/or or other optical elements capable of delivering an in focus near-to-eye image to the user, among other possibilities. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

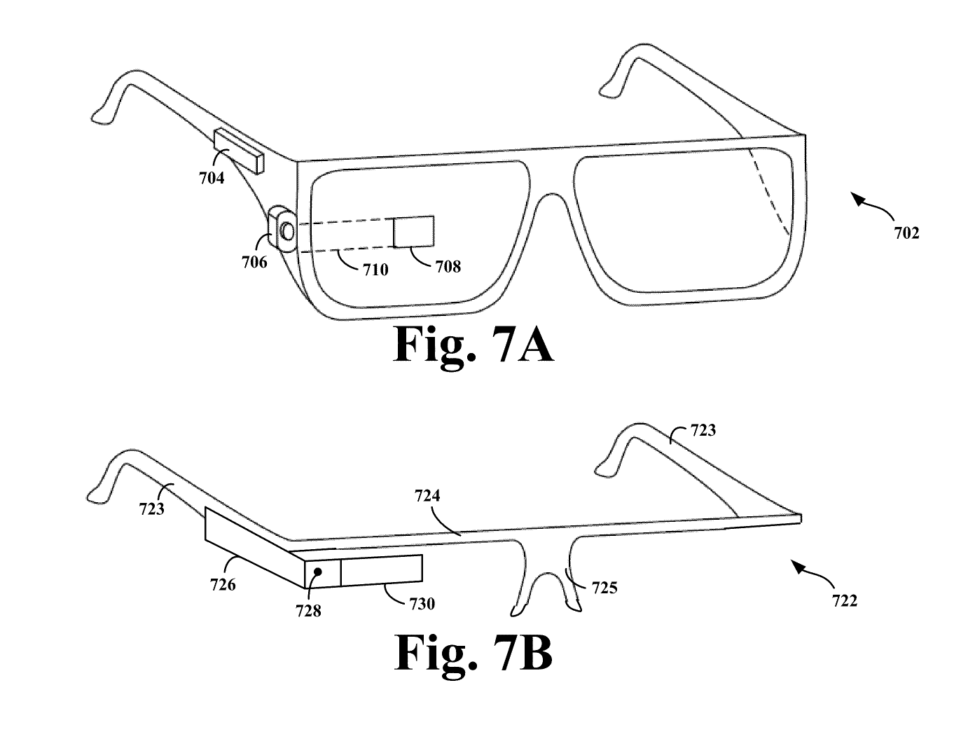

FIG. 7A illustrates another wearable computing system according to an exemplary embodiment, which takes the form of an HMD 702. The HMD 702 may include frame elements and side-arms such as those described with respect to FIGS. 6A and 6A. The HMD 702 may additionally include an on-board computing system 704 and a video camera 706, such as those described with respect to FIGS. 6A and 6B. The video camera 706 is shown mounted on a frame of the HMD 702. However, the video camera 706 may be mounted at other positions as well.

As shown in FIG. 7A, the HMD 702 may include a single display 708 which may be coupled to the device. The display 708 may be formed on one of the lens elements of the HMD 702, such as a lens element described with respect to FIGS. 6A and 6A, and may be configured to overlay computer-generated graphics in the user's view of the physical world. The display 708 is shown to be provided in a center of a lens of the HMD 702, however, the display 708 may be provided in other positions. The display 708 is controllable via the computing system 704 that is coupled to the display 708 via an optical waveguide 710.

FIG. 7B illustrates another wearable computing system according to an exemplary embodiment, which takes the form of an HMD 722. The HMD 722 may include side-arms 723, a center frame support 724, and a bridge portion with nosepiece 725. In the example shown in FIG. 7B, the center frame support 724 connects the side-arms 723. The HMD 722 does not include lens-frames containing lens elements. The HMD 722 may additionally include an on-board computing system 726 and a video camera 728, such as those described with respect to FIGS. 6A and 6B.

The HMD 722 may include a single lens element 730 that may be coupled to one of the side-arms 723 or the center frame support 724. The lens element 730 may include a display such as the display described with reference to FIGS. 6A and 6B, and may be configured to overlay computer-generated graphics upon the user's view of the physical world. In one example, the single lens element 730 may be coupled to the inner side (i.e., the side exposed to a portion of a user's head when worn by the user) of the extending side-arm 723. The single lens element 730 may be positioned in front of or proximate to a user's eye when the HMD 722 is worn by a user. For example, the single lens element 730 may be positioned below the center frame support 724, as shown in FIG. 7B.

FIG. 8 illustrates a schematic drawing of a computing device according to an exemplary embodiment. In system 800, a device 810 communicates using a communication link 820 (e.g., a wired or wireless connection) to a remote device 830. The device 810 may be any type of device that can receive data and display information corresponding to or associated with the data. For example, the device 810 may be a heads-up display system, such as the head-mounted devices 602, 702, or 722 described with reference to FIGS. 6A, 6B, 7A, and 7B.

Thus, the device 810 may include a display system 812 comprising a processor 814 and a display 816. The display 816 may be, for example, an optical see-through display, an optical see-around display, or a video see-through display. The processor 814 may receive data from the remote device 830, and configure the data for display on the display 816. The processor 814 may be any type of processor, such as a micro-processor or a digital signal processor, for example.

The device 810 may further include on-board data storage, such as memory data storage 818 coupled to the processor 814. The data storage 818 may store software and/or other instructions that can be accessed and executed by the processor 814, for example.

The remote device 830 may be any type of computing device or transmitter including a laptop computer, a mobile telephone, or tablet computing device, etc., that is configured to transmit data to the device 810. The remote device 830 and the device 810 may contain hardware to enable the communication link 820, such as processors, transmitters, receivers, antennas, etc.

In FIG. 8, the communication link 820 is illustrated as a wireless connection; however, wired connections may also be used. For example, the communication link 820 may be a wired serial bus such as a universal serial bus or a parallel bus. A wired connection may be a proprietary connection as well. The communication link 820 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 830 may be accessible via the Internet and may include a computing cluster associated with a particular web service (e.g., social-networking, photo sharing, address book, etc.).

### V. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method carried out by a computing device, the method comprising:
determining a plurality of digrams, wherein a given digram comprises two successive symbols in a plurality of symbols corresponding to a particular language;
for each of one or more of the plurality of digrams, determining a respective frequency at which the given digram occurs in the particular language;
determining an arrangement of the plurality of symbols within a plurality of input regions, wherein each of the symbols from the plurality of digrams is assigned to one of the input regions, and wherein the arrangement is such that a distance between the input regions corresponding to the symbols from a given digram positively correlates with the frequency at which the given digram occurs;
presenting a transition region and the plurality of input regions;
detecting a movement through the transition region (i) originating from a first input region and (ii) exceeding a threshold movement;
receiving an indication comprising the first-input-region symbol; and
presenting a confirmation associated with the indication.

2. The method of claim 1, wherein the plurality of input regions comprises respective letter regions, and wherein the respective symbol of each of the letter regions comprises a letter.

3. The method of claim 1, wherein the movement is a gaze-target movement.

4. The method of claim 1, wherein the transition region is circular.

5. The method of claim 1, wherein at least one of the plurality of input regions adjoins the transition region.

6. The method of claim 5, wherein every input region adjoins the transition region.

7. The method of claim 1, wherein the symbol comprises a letter.

8. The method of claim 1, wherein the threshold movement is a distance.

9. The method of claim 1, wherein the threshold movement is a displacement.

10. The method of claim 1, wherein the threshold movement is a velocity.

11. The method of claim 1, wherein the threshold movement is a movement within a selection region.

12. The method of claim 1, wherein presenting the confirmation associated with the indication comprises presenting the confirmation associated with the indication within the transition region.

13. The method of claim 1, further comprising executing a command associated with the indication.

14. A computing device comprising:
a processor;
data storage; and
instructions stored on the data storage that are executable by the processor to cause the computing device to:
determine a plurality of digrams, wherein a given digram comprises two successive symbols in a plurality of symbols corresponding to a particular language;
for each of one or more of the plurality of digrams, determine a respective frequency at which the given digram occurs in the particular language;
determine an arrangement of the plurality of symbols within a plurality of input regions, wherein each of the symbols from the plurality of digrams is assigned to one of the input regions, and wherein the arrangement is such that a distance between the input regions corresponding to the symbols from a given digram positively correlates with the frequency at which the given digram occurs;
present a transition region and the plurality of input regions;
detect a movement through the transition region (i) originating from a first input region and (ii) exceeding a threshold movement;
receive an indication comprising the first-input-region symbol; and
present a confirmation associated with the indication.

15. The computing device of claim 14, wherein the plurality of input regions comprises respective letter regions, and wherein the respective symbol of each of the letter regions comprises a letter.

16. The computing device of claim 14, wherein the movement is a gaze-target movement.

17. The computing device of claim 14, wherein the transition region is circular.

18. The computing device of claim 14, wherein at least one of the plurality of input regions adjoins the transition region.

19. The computing device of claim 18, wherein every input region adjoins the transition region.

20. The computing device of claim 14, wherein the symbol comprises a letter.

21. A non-transitory computer-readable medium having instructions stored thereon that are executable by a computing device to cause the computing device to:
determine a plurality of digrams, wherein a given digram comprises two successive symbols in a plurality of symbols corresponding to a particular language;
for each of one or more of the plurality of digrams, determine a respective frequency at which the given digram occurs in the particular language;
determine an arrangement of the plurality of symbols within a plurality of input regions, wherein each of the symbols from the plurality of digrams is assigned to one of the input regions, and wherein the arrangement is such that a distance between the input regions corresponding to the symbols from a given digram positively correlates with the frequency at which the given digram occurs;
present a transition region and the plurality of input regions;
detect a movement through the transition region (i) originating from a first input region and (ii) exceeding a threshold movement;
receive an indication comprising the first-input-region symbol; and
present a confirmation associated with the indication.

22. The computer-readable medium of claim 21, wherein the plurality of input regions comprises respective letter regions, and wherein the respective symbol of each of the letter regions comprises a letter.

23. The computer-readable medium of claim 21, wherein the movement is a gaze-target movement.

24. The computer-readable medium of claim 21, wherein the transition region is circular.

25. The computer-readable medium of claim 21, wherein at least one of the plurality of input regions adjoins the transition region.

26. The computer-readable medium of claim 21, wherein every input region adjoins the transition region.

27. The computer-readable medium of claim 21, wherein the symbol comprises a letter.
